(19) United States
(12) Patent Application Publication
(10) Pub. No.: US 2007/0292694 A1
(43) Pub. Date: Dec. 20, 2007

(54) Making glazed panels puttied with hot melt adhesive

(76) Inventor: Robert A. Rauch, Dove Canyon, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/471,249

(22) Filed: Jun. 19, 2006

(51) Int. Cl. B05D 5/10; B32B 18/00; B32B 17/06

(52) U.S. Cl. 428/426; 427/208.2; 428/210

(57) ABSTRACT

A method for making a glazed panel, such as a stained glass window, using a hot melt adhesive instead of a conventional, noisome, slow-drying putty, includes the provision of a glass pane, such as a leaded or stained glass pane, having a peripheral margin, a soft metal came, such as a lead came, having a U-shaped channel configured to receive the peripheral margin of the glass pane, and an elongated strip of a hot melt adhesive disposed in the channel of the came. The glass pane is heated, e.g., with a hot air gun, to a temperature above the melting point of the adhesive and its peripheral margin is then inserted into the channel of the came such that the heated peripheral margin of the glass causes the adhesive to melt and adhere the peripheral margin of the glass pane to the interior surface of the channel of the came.

### BACKGROUND

This invention relates to making glazed panels, such as leaded glass or stained glass windows, using a hot melt (HM) adhesive instead of conventional glazing putty.

Glazed panels incorporating leaded and/or stained glass panes have been used as decorative windows in furniture and buildings, such as churches and monasteries, for many centuries, and the process used for their manufacture has remained relatively unchanged during that time. Glazed panels comprise a plurality of glass pieces, or panes, that are clear, colored, leaded, or which incorporate simple or elaborate painted designs that may be fired into the glass, and which are arranged in a flat, two-dimensional pattern and joined together at adjacent opposing edges by means of a “came,” i.e., an elongated rod or bar of a soft metal, typically lead or a lead alloy of variable hardness, containing either one or two U-shaped channels into which the peripheral margins of the glass pieces are received. Came with a U-shaped cross-section, i.e., containing only one elongated channel, is typically used for the outer circumference of the panel, and receives glass on only one of its sides. Came with an H-shaped cross-section, and hence, containing two oppositely directed channels, is used for the center portion of the panel, and receives the respective edge margins of adjacent pairs of glass panes in each of its opposite sides.

During assembly, each pane of the panel is cut to incorporate the particular shape, or outline, desired for that piece, and is then laid out on the surface of a glazing table, with the came conformably shaped around its periphery to form a matrix, and nails, tacks, or “glazing points” are used to temporarily hold the assembled pieces to the work surface. The glass and came pieces of the panel are typically assembled beginning at one corner of the panel, and built up away from that corner. The respective end flanges of the came are tucked under the “ears,” or flanges, of the meeting pieces of came, or alternatively, the ends of the came pieces can join each other at mitered joints. When the panel is completely assembled, the lead came is soldered at the joints where the came strips meet each other using a lead/tin solder, e.g., a 60/40 alloy thereof.

The final step in the assembly of a glazed panel is the application of a waterproofing putty, typically made of a solvent such as linseed oil, chalk, and optionally, a drying agent, which is forced in the interior space between the glass and the lead came, to strengthen and waterproof the panel. One of the drawbacks associated with making glazed panels relates to this puttying process. In particular, the putty used has an unpleasant odor that permeates the area in which it is used, and addition, takes approximately 5 to 10 days to dry (i.e., for the noisome solvents and dryers to evaporate) so that the panel or window is sealed against wind and moisture and has sufficient strength to be hung, e.g., in a window frame or a cabinet door.

Accordingly, a long felt but as yet unsatisfied need exists for a new method and material for puttying glazed panels that eliminates the unpleasant odor and cleanup procedures associated with the application of conventional putty, and that enable a glazed panel to be puttied as it is being built, so that when the joints of the came pieces are soldered, the panel is finished except for minor cleanup and polishing, and is strong enough to be hung immediately.

### BRIEF SUMMARY

In accordance with the exemplary embodiments thereof described herein, the present invention provides methods and materials that eliminate the need for the application of conventional putty typically applied to a glazed panel after soldering of the came strips, including the bad odors, messy cleanup procedures, and extensive drying times associated therewith, and enable the panel to be puttied as it is being built up, so that when the joints of the came are soldered, the panel is complete and can be immediately hung and/or exposed to the elements.

In one exemplary embodiment, the novel method comprises providing a planar glass piece, or pane, having an elongated peripheral margin, and an elongated came having at least one U-shaped channel configured to receive the peripheral margin of the glass pane therein. An elongated strip of a hot melt (HM) adhesive having a selected melting point (MP) is inserted into the channel of the came. The glass pane is then heated, e.g., with a hot air gun, to a temperature greater than the MP of the HM adhesive, and the peripheral margin of the heated glass pane is then inserted into the channel of the came and against the HM adhesive such that the glass contacts and melts the adhesive and causes it to flow around the peripheral margin of the glass pane and adhere it to the interior surfaces of the channel of the came. The HM adhesive is then allowed to cool below its melting point to a solid structure forming a strong, moisture-proof bond between the glass and the came, thereby eliminating the need for the objectionable puttying process of the prior art. The joints of the came pieces are then soldered, and the panel is finished, except for minor cleanup and polishing, and is ready to be hung immediately.

In an exemplary preferred embodiment, the HM adhesive comprises about 25% by weight of paraffin, about 35% by weight of ethylene vinyl acetate (EVA), and about 40% by weight of Pexalyn 9085, or other tackifier resin. The HM adhesive may also be formulated to include trace amounts of an antioxidant, such as butylated hydroxytoluene (BHT), and/or trace amounts of a coloring and/or a scenting agent. For example, the coloring agent can include a small amount of fine carbon black particles, such as that derived from burning acetylene in an atmosphere with reduced oxygen, or fine particles of pure aluminum of about 1-3 microns in size. The coloring agent enables the color of the adhesive to closely match the color or finish of the came with which it is being used. A scenting agent, such as the type used to scent candles, can be added to give off a pleasant odor when the HM adhesive is melted, and more practically, also serve an indicator to the user that the HM adhesive has been successfully melted. In an exemplary embodiment, the HM adhesive can have a melting point (MP) of from between about 120° F. to about 156° F., and this parameter can be adjusted by controlling the MP of the paraffin used in its formulation. For example, the paraffin can be selected to have a melting point (MP) of from between about 51° C. to about 69° C.

In one advantageous embodiment, the HM adhesive can be supplied in long, thin flat strips that match the dimensions of the channels of the came with which it is being used, e.g., 6 ft. long strips that are 0.040 in. thick by 0.184 in. wide, and manually inserted in the came channels by the user at the time of panel assembly. In another possible embodiment, the HM adhesive can be supplied pre-inserted in the came, and preferably, pre-adhered to the interior surfaces of the channel(s) thereof, such that the adhesive can then be cut, stretched and formed along with the came during panel assembly, in a manner similar to that in which conventional came is used.

The HM adhesive enables stained or leaded glass panels to be fabricated in a method that eliminates the need for the application of conventional, messy glazing putty and the lengthy drying time that it requires, and enables the panels to be puttied as they are being assembled so that, when the joints of the came are soldered together, assembly of the panel is complete and the panel is ready for immediate use.

A better understanding of the above and many other features and advantages of the methods and materials of the present invention may be obtained from a consideration of the detailed description of some exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is a front elevation view of an exemplary embodiment of a glazed panel, such as a stained glass window panel, in accordance with the prior art;

FIG. 2 is a partial cross-sectional view through an outer circumference came, i.e., having a single channel, of the glazed panel of FIG. 1, as seen along the lines of the section 2-2 taken therein;

FIG. 3 is a partial cross-sectional view through an internal came, i.e., having a pair of oppositely directed channels, of the glazed panel of FIG. 1, as seen along the lines of the section 2-2 taken therein;

FIG. 4 is a top plan view of an exemplary embodiment of a strip of hot melt (HM) adhesive useful for fabricating glazed panels in accordance with the present invention;

FIG. 5 is a cross-sectional view through the HM adhesive strip of FIG. 4, as seen along the lines of the section 5-5 taken therein;

FIG. 6 is a partial cross-sectional elevation view of an apparatus for making the HM adhesive strip of FIG. 4 in small quantities;

FIG. 7 is a schematic side elevation view of a roll-type apparatus for making the HM adhesive strip of FIG. 5 in large quantities; and,

FIGS. 8-10 are sequential partial cross-sectional views showing the assembly of a glazed panel in accordance with the present invention.

### DETAILED DESCRIPTION

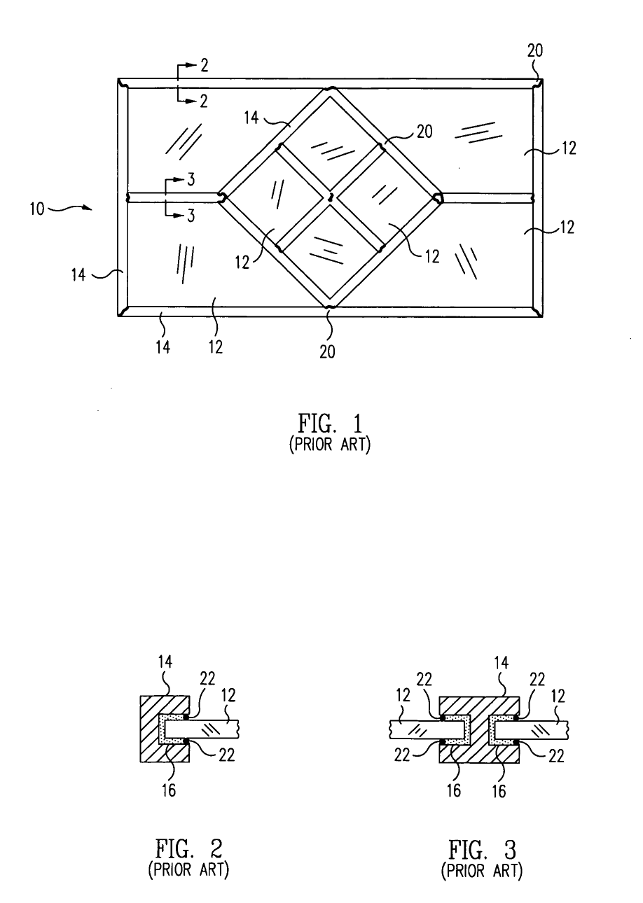

FIG. 1 is a front elevation view of an exemplary embodiment of a glazed panel 10, such as a stained glass window panel, in accordance with the prior art. As may be seen by reference to the figure, the exemplary glazed panel comprises a plurality of glass pieces, or panes 12, that may be clear, colored, leaded, or painted with translucent, colored designs that may be painted on and/or fired into the glass, and which are arranged in a flat, two-dimensional pattern or matrix and joined together at adjacent opposing edges by means of an elongated rod or bar 14 of a soft metal called a came. The came is typically made of lead or an alloy thereof and contains either one or two U-shaped channels 16 into which the peripheral margins of the glass pieces are inserted. However, the came can also be made of other pliable metal or non-metallic materials, e.g., copper or plastic.

As illustrated in the cross-sectional view of FIG. 2, a came 14 having only a single elongated channel 16 is typically used for the outer circumference of the panel 10, and receives glass on only one of its two opposite sides. On the other hand, came with an H-shaped cross-section, and hence, containing two oppositely directed channels 16, is typically used for the center portion of the panel, and receives the respective edge margins of adjacent pairs of the glass panes 12 in each of its opposite sides, as illustrated in the cross-sectional view of FIG. 3.

During assembly, each pane 12 of the glazed panel 10 is cut to a pattern incorporating a particular shape, or circumferential outline, desired for that piece, and is then temporarily fixed in place on the surface of a glazing table, with the came pieces 14 shaped conformably around its periphery to form a matrix, and then temporarily nailed or tacked to the work surface. In the particular exemplary embodiment illustrated in FIG. 1, the edges of the glass panes 14 all have straight-line profiles, but in other embodiments, one or more of the edges of one or more of the pieces may incorporate a two-dimensional curvature. The glass and came pieces 12 and 14 are typically assembled beginning at one corner of the panel 10, and then working away from the starting corner. The ends of the came are tucked under the “ears,” or flanges, of the intersecting pieces of came to form overlapping joints, or alternatively, their ends can be cut to join each other at mitered joints 20. When the panel is completely assembled, the lead came is soldered at the joints where the came strips meet each other using a soldering iron, a flux, and a lead/tin alloy of solder, typically a 60/40, or “eutectic,” alloy thereof.

The final step in the assembly of the glazed panel 10 involves the application of a waterproofing putty 22, typically comprised of a solvent, such as linseed oil, a filler, such as chalk, and optionally, a drying agent, which is forced with a knife or spatula into the interior space between the glass panes 12 and the channels 16 of the lead came 14, to strengthen and waterproof the panel, as illustrated in FIGS. 2 and 3. One of the drawbacks of making such prior art glazed panels relates to this puttying process. In particular, the putty has a nauseous odor that permeates the area in which it is used, and additionally, takes approximately 5 to 10 days to dry, i.e., for the panel to have sufficient strength to be removed from the work table and hung vertically in, e.g., a window frame or a cabinet door.

In accordance with the present invention, a hot melt (HM) adhesive and a method for its use are provided for making glazed panels 10 of the type described above that eliminate the need to apply conventional putty 22 to the panel after the joints 20 of the came strips 14 are soldered, thereby eliminating the bad odors, messy cleanup procedures, and extensive drying times associated therewith. Use of the novel method and adhesive enables the panel to be puttied as it is being assembled, so that when the joints of the came are soldered, the panel is finished and can be handled, used and hung immediately.

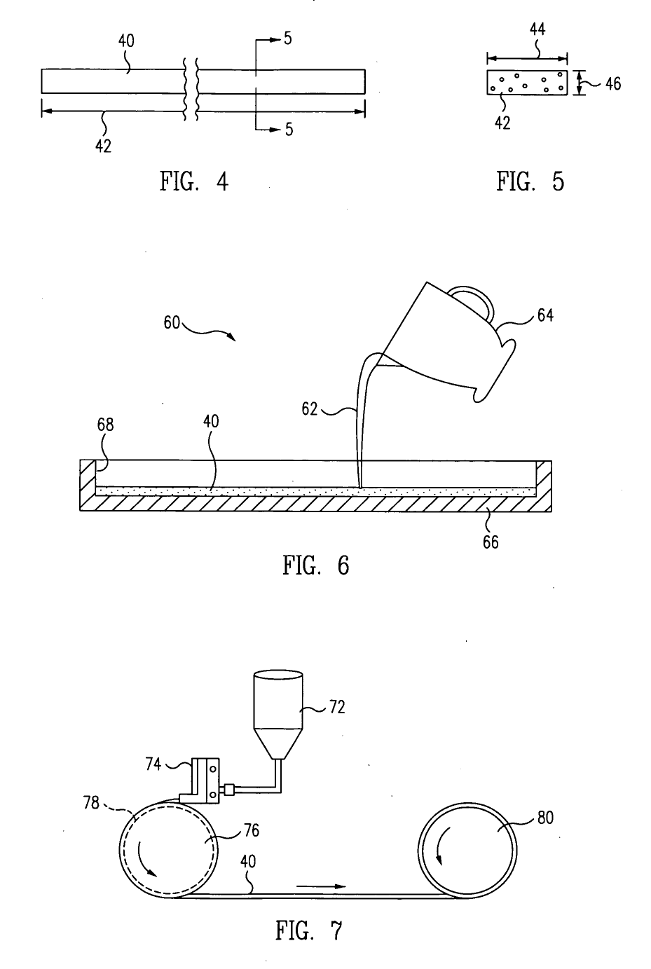

An exemplary embodiment of a HM adhesive strip 40 adapted for use with the method of the present invention is illustrated in the top plan and cross-sectional views of FIGS. 4 and 5, respectively. As may be seen by reference to these two figures, the flat, elongated HM adhesive strip has a length 42, width 44 and thickness 46 selected such that the strip fits snugly at the bottom of one of the channels 16 of a lead came 14. As those of skill in the art will appreciate, lead came, such as that sold by Mayco Industries, Inc., Birmingham, Ala., is sold in a variety of cross-sectional shapes, depending on the artistic effect to be achieved in the panel and the thickness of the glass panes 14 with which it is to be used, and typically, in either straight, 6 foot long, lengths, or by weight and wound onto a spool.

Thus, in one exemplary preferred embodiment, the HM adhesive strip 40 can be provided in either 6 ft. long strips, to accommodate corresponding 6 ft. long, straight came strips, or alternatively, sold by weight or total length and wound onto a spool, from which it can then be cut in any length desired. As an example, for glass panes 14 having a marginal edge thickness of about 0.120-0.125 in., the HM adhesive strip, regardless of length, preferably has a thickness 46 of about 0.040 in. and a width 44 of about 0.184 in. to accommodate the channel 16 of an appropriately sized came piece 14. Of course, HM adhesive strips 40 of other lengths, thicknesses and widths can also be confected, depending on the particular glazing application at hand.

Alternatively, the HM adhesive strips 40 can be supplied pre-inserted in the channels 16 of the came 14, and preferably, pre-adhered to the interior floor and side surfaces of the channels thereof, so that they can be cut, stretched and formed simultaneously with the came during panel assembly, in a manner similar to that in which conventional came is used.

In a preferred exemplary embodiment thereof, the HM adhesive comprises about 25% by weight of paraffin, about 35% by weight of ethylene vinyl acetate (EVA), and about 40% by weight of Pexalyn 9085, or another tackifier resin. The HM adhesive may also be formulated to include trace amounts of an antioxidant, such as butylated hydroxytoluene (BHT), and/or trace amounts of a coloring agent and/or a scenting agent. For example, the coloring agent can include a small amount of fine carbon black particles, such as that derived from burning acetylene in a reduced oxygen atmosphere, or fine particles of pure aluminum, of about 1-3 microns in size. The coloring agent enables the color of the adhesive to closely match the finish of the came with which it is being used.

An organic scenting agent, such as the type used to scent candles, can also be added to give off a pleasant odor when the HM adhesive is melted, and thereby also serve as an indicator to the user during panel assembly that the HM adhesive has been melted and is ready to adhere. In an exemplary embodiment, the HM adhesive can have a melting point (MP) of from between about 120° F. to about 156° F., and this parameter can be largely controlled by the MP of the paraffin used in its formulation. For example, the paraffin can be selected to have a melting point (MP) of from between about 51° C. to about 69° C. to produce the foregoing range of adhesive MPs.

An inexpensive apparatus 60 for making small quantities of the elongated HM adhesive strips 40 of the invention is illustrated in FIG. 6. In this embodiment, a quantity of the above adhesive 62 in molten form, i.e., heated to a temperature above its MP, is poured from a container 64 into a silicon rubber mold 66 having a slot 68 of a length and width corresponding to those desired in the finished strip, i.e., corresponding in length and width to the channel of a came with which the HM adhesive strip is to be used. The thickness of the strip produced is controlled by controlling the amount of adhesive dispensed into the mold, and any excess amounts poured can be skimmed off with a spatula. After the adhesive strip 40 is poured, it is allowed to cool to a temperature below the MP of the adhesive and then simply stripped out of the mold and inserted into the channel 16 of a came for use in the fabrication of a glazed panel 10, in the manner described below.

A more elaborate, roll process apparatus 70 for making large volumes of the elongated HM adhesive strips 40 is illustrated in FIG. 7. In this embodiment, the molten adhesive is retained in a heated container 72 and fed under pressure to a “slot die applicator” apparatus 74, such as the model MR 1300 slot die applicator available from ITW Dynatec Co., Hendersonville, Tenn. The applicator ejects one or more streams of the molten adhesive onto a rotating “chill roller” 76 containing a corresponding number of slots 78, each similar to that of the mold 66 of FIG. 6. The chill roller incorporates a circulating refrigerant that functions to chill the roller, and hence, the strips of molten adhesive deposited thereon by the slot die applicator, causing the adhesive strip to cool and solidify to a solid strip of adhesive 40, which is then stripped off of the chill roller and spooled onto a take-up spool 80.

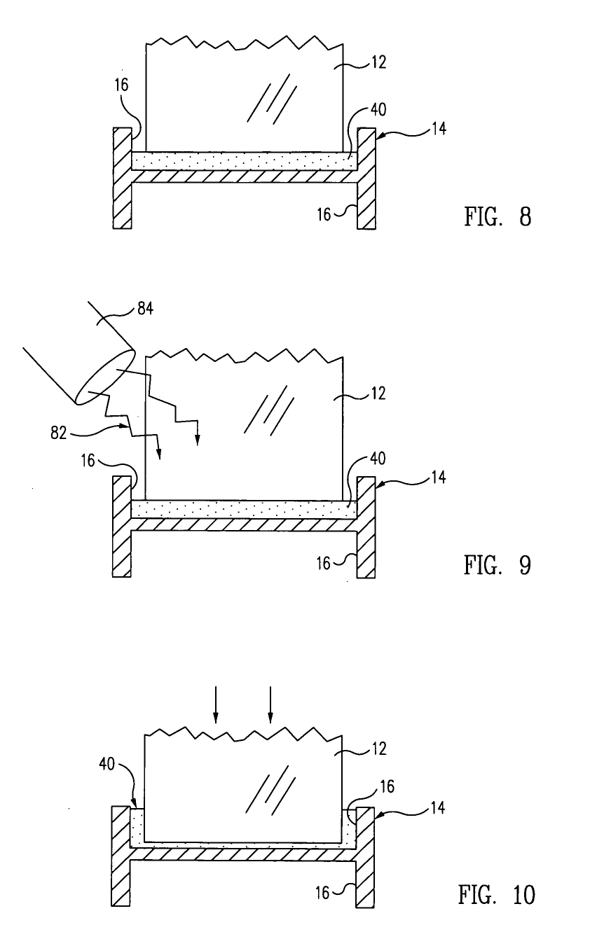

FIGS. 8-10 illustrate sequential steps in the assembly of a glazed panel 10 in accordance with a method and using the HM adhesive of the present invention. In the exemplary method illustrated, a planar glass piece, or pane 12, of the panel and an elongated came 14 having at least one U-shaped channel 16 configured to receive a peripheral margin of the glass pane, are provided. In the embodiment shown in the figures, the came 14 comprises an “interior” came having an H-shaped cross section containing a pair of oppositely directed, U-shaped channels 16. An elongated strip 40 of the hot melt (HM) adhesive described above, which has a selected melting point (MP) of, e.g., from between about 120° F. to about 156° F., is inserted into the bottom of the channel of the came, as illustrated in FIG. 8. As discussed above, it is also possible to provide the came with the HM adhesive strip pre-installed in its channel(s).

As illustrated in FIG. 9, a peripheral margin of the glass pane 12 to be joined with the came 14 is then heated, e.g., with heated air 82 from a hot air gun 84, to a temperature that is greater than the MP of the HM adhesive, and the peripheral margin of the heated glass pane is then pressed into the channel 16 of the came, in the direction of the arrows shown in FIG. 10, such that the edge of the heated glass contacts the HM adhesive strip 40 and causes it to melt and flow around the peripheral margin of the glass and adhere the peripheral margin of the glass pane to the interior surfaces of the channel of the came, as illustrated in FIG. 10.

The HM adhesive is then allowed to cool below its melting point, whereupon it forms a strong, moisture-proof bond between the glass pane 12 and the came 14, thereby eliminating the need for the objectionable putty and puttying process of the prior art. The joints of the panel came pieces can then be soldered to each other in the conventional manner, and the panel is finished, except for minor cleanup and polishing, and is both sufficiently moisture proof and strong enough to be handled or hung immediately without any requisite putty drying period.

The novel method and HM adhesive of the present invention thus enable glazed panels 10, such as leaded glass or stained glass window panels, to be assembled using a hot melt (HM) adhesive instead of conventional glazing putty, thereby enabling the panel to be puttied as and when it is being assembled, so that when the joints 20 of the came pieces 14 are ultimately soldered, the panel is then essentially complete and can be hung immediately and exposed to the elements without waiting for the putty to dry.

By now, those of skill in this art will appreciate that many modifications, substitutions and variations can be made in and to the materials, apparatus and methods of the present invention without departing from its spirit and scope. In light of this, the scope of the present invention should not be limited to that of the particular embodiments illustrated and described herein, which are only exemplary in nature, but instead, should be fully commensurate with that of the claims appended hereafter and their functional equivalents.

What is claimed is:

1. A method for making a glazed panel, the method comprising:
providing a glass pane having an elongated peripheral margin;
providing an elongated came having a U-shaped channel configured to receive the peripheral margin of the glass pane;
providing an elongated strip of a hot melt (HM) adhesive having a selected melting point (MP);
inserting the strip of the HM adhesive into the channel of the came;
heating the glass pane to a temperature that is greater than the MP of the HM adhesive; and,
inserting the peripheral margin of the heated glass pane into the channel of the came such that the heated glass causes the adhesive to melt and adhere the peripheral margin of the glass pane to an interior surface of the channel of the came.

2. The method of claim 1, wherein the HM adhesive comprises:
about 25% by weight of paraffin;
about 35% by weight of ethylene vinyl acetate (EVA); and,
about 40% by weight of Pexalyn 9085.

3. The method of claim 2, wherein the HM adhesive further comprises a trace amount of an antioxidant, a coloring agent or a scenting agent.

4. The method of claim 3, wherein the antioxidant comprises butylated hydroxytoluene (BHT).

5. The method of claim 3, wherein the coloring agent comprises particles of carbon black or aluminum.

6. The method of claim 1, wherein the came comprises lead or a lead alloy.

7. The method of claim 1, wherein the melting point (MP) of the HM adhesive is from between about 120° F. to about 156° F.

8. The method of claim 2, wherein the paraffin has a melting point (MP) of from between about 51° C. to about 69° C.

9. The method of claim 1, wherein the glass pane comprises leaded glass.

10. The method of claim 1, wherein the glass pane comprises stained glass.

11. A glazed panel made in accordance with the method of claim 1.

12. A came for making glazed panels, comprising:
an elongated rod made of a soft material and containing at least one axial channel having a length, a width and a depth configured to receive a peripheral margin of a glass pane in a tongue-and-groove relationship therein; and,
an elongated strip of a hot melt (HM) adhesive disposed in the channel, the strip having a selected thickness and a length and width respectively substantially equal to the length and width of the channel.

13. The came of claim 12, wherein the strip of HM adhesive is adhered to at least a floor of the channel.

14. The came of claim 12, wherein the HM adhesive comprises about 25% by weight of paraffin, about 35% by weight of ethylene vinyl acetate (EVA), and about 40% by weight of a tackifier resin.

15. The came of claim 12, wherein the strip of HM adhesive has a length of about 6 ft., a thickness of about 0.040 in. and a width of about 0.184 in.

16. The came of claim 12, wherein the came comprises lead or a lead alloy.

17. A method for making a glazed panel with the came of claim 12, the method comprising:
providing a glass pane with a peripheral margin having a length, a curvature and a thickness adapted to be received in the channel of the came in a tongue-and-groove relationship;
forming the came and the adhesive to conform to the curvature of the peripheral margin of the glass pane;
cutting the came and the adhesive to a length conforming to the length of the peripheral margin of the glass pane;
inserting the peripheral margin of the glass pane into the channel; and,
heating the glass pane such that the glass melts the HM adhesive and causes the adhesive to adhere the peripheral margin of the glass pane to an interior surface of the channel.

18. A glazed panel, comprising:
a plurality of glass panes disposed adjacent to each other in a two-dimensional pattern, each pane having a peripheral edge corresponding in length and curvature to an opposing peripheral edge of an adjacent one of the panes;
a came extending along the corresponding opposing peripheral edges of adjacent pairs of the panes, the came having a pair of oppositely facing channels, each channel receiving a peripheral margin of a respective one of the adjacent pair of panes in a tongue-and-groove relationship; and,
a hot melt (HM) adhesive adhering respective ones of the peripheral margins of the adjacent pairs of glass panes to an interior surface of a respective one of the channels of the came.

19. The glazed panel of claim 18, wherein peripheral edges of at least some of the adjacent glass panes define a peripheral edge of the glazed panel, and further comprising:
a came extending around the peripheral edge of the panel, the came having a channel receiving a peripheral margin of the panel in a tongue-and-groove relationship; and,
a hot melt (HM) adhesive adhering the peripheral margin of the panel to an interior surface of the channel of the came.

20. The glazed panel of claim 18, wherein the panel comprises a leaded glass window or a stained glass window.
